(19) United States
(12) Patent Application Publication
(10) Pub. No.: US 2020/0295521 A1
(43) Pub. Date: Sep. 17, 2020

(54) All Polarization-Maintaining, Passively Mode-Locked Linear Fiber Laser Oscillator

(71) Applicant: Vescent Photonics LLC, Golden, CO (US)

(72) Inventors: Tsung-han Wu, Denver, CO (US); Eng Hiang Mark Yeo, Lakewood, CO (US); Kevin Knabe, Frederick, CO (US); Kurt Richard Vogel, Boulder, CO (US)

(21) Appl. No.: 16/813,199

(22) Filed: Mar. 9, 2020

Related U.S. Application Data
(60) Provisional application No. 62/816,582, filed on Mar. 11, 2019.

(51) Int. Cl. H01S 3/067; H01S 3/11; H01S 3/16; H01S 3/08

(52) U.S. Cl. CPC H01S 3/06716; H01S 3/08013; H01S 3/1608; H01S 3/1118

(57) ABSTRACT

An example all polarization-maintaining, passively mode-locked linear fiber laser oscillator has a linear cavity. A semiconductor saturable absorber mirror (SESAM) is disposed at one end of the linear cavity. A polarization-maintaining gain fiber is operatively associated with the SESAM in the linear cavity, the gain fiber having normal dispersion. A polarization-maintaining undoped fiber is operatively associated with the SESAM in the linear cavity, the undoped fiber having anomalous dispersion. An output coupler is configured to generate laser light output from the linear cavity.

### PRIORITY CLAIM

This application claims the priority filing benefit of U.S. Provisional Patent Application No. 62/816,582 filed Mar. 11, 2019 titled “All Polarization-Maintaining, Passively Mode-Locked Linear Fiber Laser Oscillator” of Wu, et al, hereby incorporated by reference for all that is disclosed as though fully set forth herein.

### GOVERNMENT LICENSE RIGHTS

This invention was made with government support under government contract number FA9453-17-C-0039 awarded by the United States Department of Defense. The government has certain rights in the invention.

### BACKGROUND

Mode-locked fiber lasers have been of considerable interest for the last 25 years based on their usefulness in applications such as optical frequency combs, laser machining, ultrafast microscopy, and various other research areas. Mode-locking is a technique in optics by which a laser can be made to produce pulses of light of extremely short duration, on the order of picoseconds (10⁻¹² s) or femtoseconds (10⁻¹⁵ s). A laser operated in this way is sometimes referred to as a femtosecond laser, for example in modern refractive surgery. The basis of the technique is to induce a fixed-phase relationship between the longitudinal modes of the lasers resonant cavity. Constructive interference between these modes can cause the laser light to be produced as a train of pulses. The laser is then said to be ‘phase-locked’ or ‘mode-locked’.

Pulsed mode-locked lasers may be viewed in the frequency domain as a series of continuous lasers spaced out by the pulse repetition rate. When both the offset and the spacing between these discrete continuous lasers is controlled, the mode-locked laser is called an optical frequency comb. For applications in optical frequency combs, recent designs from NIST have demonstrated a passively mode-locked laser constructed of all polarization-maintaining (PM) optical fiber and fiber components in a simple linear cavity.

A PM optical fiber is highly birefringent and is capable of guiding maintaining light in one of two orthogonal linear polarization states. Because of this property, the polarization state of the circulating light is preserved in the laser cavity, resulting in an oscillator that is very robust to environmental disturbances. However, oscillators constructed from fiber with anomalous dispersion are not ideal for all frequency comb applications. Because of the large net anomalous dispersion, the pulse widths for this design are larger, when compared with other ultrafast oscillators that are dispersion managed. Therefore, this design suffers from increased phase noise in optical frequency comb applications.

There do exist dispersion-managed PM cavity designs that reduce overall phase noise of the oscillators, but these either contain non-PM components, free-space components, or individual components that are used to lower the net dispersion.

### BRIEF DESCRIPTION OF THE DRAWINGS

FIG. 1 is an example all polarization-maintaining, passively mode-locked linear fiber laser oscillator.

FIG. 2 is a schematic diagram of the example fiber laser oscillator of FIG. 1.

FIG. 3 is a schematic diagram of an example “output coupler” configuration of an example all polarization-maintaining passively mode-locked linear fiber laser oscillator.

FIG. 4 is a schematic diagram of an example “WDM” configuration of an example all polarization-maintaining passively mode-locked linear fiber laser oscillator.

FIG. 5 is a schematic diagram of an example “mid-tap” configuration of an example all polarization-maintaining passively mode-locked linear fiber laser oscillator.

### DETAILED DESCRIPTION

Passive mode-locking is achieved by introducing a loss mechanism that promotes pulsed operation, i.e. high peak power, over continuous wave operation (low peak power). Passive mode-locking can be achieved using a saturable absorber mirror (SAM) configured to have increasing reflectivity as the incident pulse energy is increased.

Another important aspect to achieving mode-locking is dispersion management within the laser cavity. Dispersion is introduced when laser light passes through intra-cavity materials. Different optical materials have a characteristic dispersion per unit length, β₂ which is defined as the second derivative of the refractive index n with respect to the optical frequency ω, as expressed by Equation 1 (EQN 1).

$${β}_{2} = \frac{{d}^{2} n}{d {ω}^{2}} \qquad EQN 1$$

When β₂ is negative (positive), the optical material is referred to as having anomalous (normal) dispersion. If the round-trip dispersion in the laser cavity is too high, the desired ultrashort pulses will not be attainable. Dispersion management involves introducing anomalous and normal dispersion optical elements into the laser cavity to keep the round-trip dispersion low.

An example passively mode-locked laser is disclosed herein as it includes a linear cavity, and at least a saturable absorber mirror disposed at one end of the linear cavity. The example passively mode-locked laser also includes polarization-maintaining gain fiber in the linear cavity, the gain fiber having a normal dispersion output coupler. The example passively mode-locked laser also includes a polarization-maintaining undoped fiber in the linear cavity, the undoped fiber having an anomalous dispersion output coupler.

Before continuing, it is noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

It is further noted that as used herein, the terms “includes” and “including” mean, but is not limited to, “includes” or “including” and “includes at least” or “including at least.” The term “based on” means “based on” and “based at least in part on.”

In addition, “polarization maintaining fiber” as used herein means, but is not limited to, a fiber that has a waveguided core that also has a birefringence that allows guidance of two orthogonal polarization states along its two principal polarization axes.

“Anomalous dispersion” as used herein means, but is not limited to, the second derivative of the refractive index with respect to optical frequency is less than zero

$$( \frac{{\partial }^{2} n}{\partial {ω}^{2}} < 0 \frac{{s}^{2}}{m} )$$

“Normal dispersion” as used herein means, but is not limited to, the second derivative of the refractive index with respect to optical frequency is greater than zero

$$( \frac{{\partial }^{2} n}{\partial {ω}^{2}} > 0 \frac{{s}^{2}}{m} )$$

“Mode-locking” as used herein means, but is not limited to, a technique in optics by which a laser can be made to produce pulses of light of extremely short duration, on the order of picoseconds (10⁻¹² s) or femtoseconds (10⁻¹⁵ s). A laser operated in this way is sometimes referred to as a femtosecond laser, for example in modern refractive surgery. The basis of the technique is to induce a fixed-phase relationship between the longitudinal modes of the laser's resonant cavity. Constructive Interference between these modes can cause the laser light to be produced as a train of pulses. The laser is then said to be ‘phase-locked’ or ‘mode-locked’.

“Repetition rate” as used herein means, but is not limited to, the frequency with which pulses exit the fiber laser oscillator.

“Second order dispersion” as used herein means, but is not limited to, the 2nd derivative of the refractive index of a material or waveguide with respect to either frequency or wavelength. The preferred units used here are for

$${β}_{2} = \frac{{\partial }^{2} n}{\partial {ω}^{2}}$$

are in

$$\frac{{s}^{2}}{m} .$$

“Comb-locker” as used herein means, but is not limited to, a device consisting of a fiber collimator, a cat's eye lens, and a semiconductor saturable absorber mirror (SESAM).

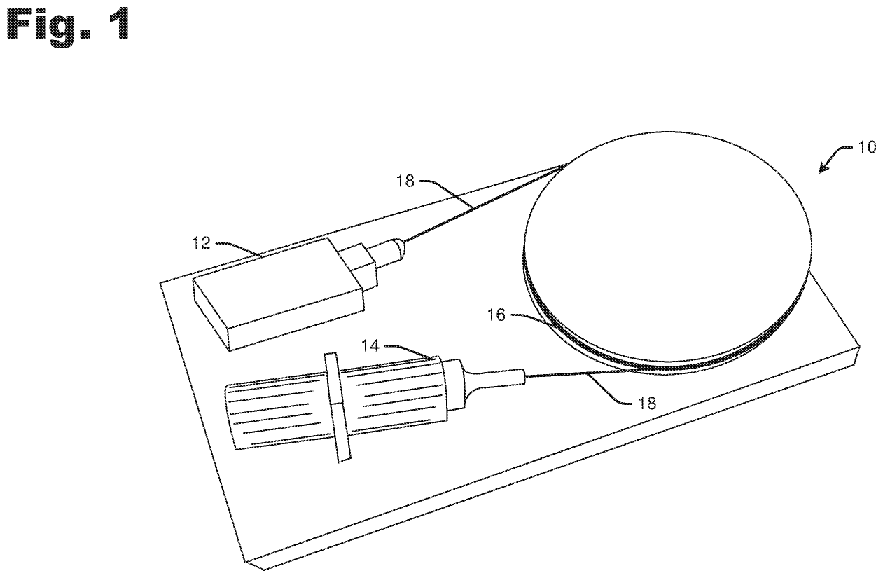

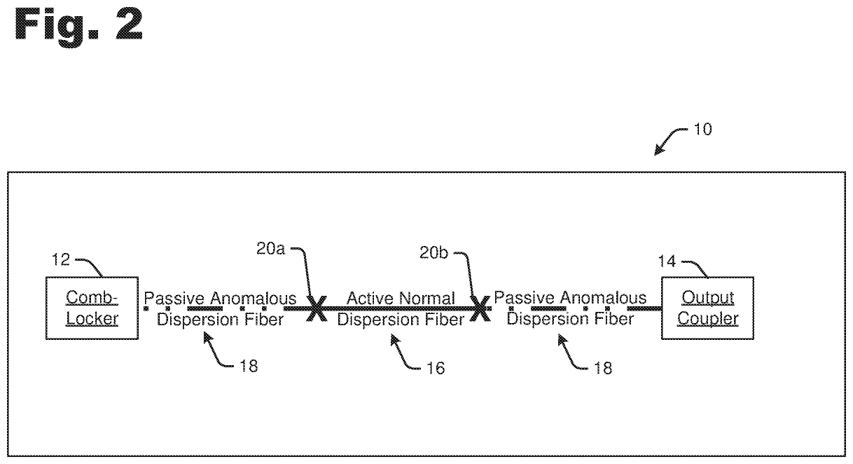

FIG. 1 is an example all polarization-maintaining, passively mode-locked linear fiber laser oscillator 10. FIG. 2 is a schematic diagram of the example fiber laser oscillator 10 of FIG. 1. An example all polarization-maintaining, passively mode-locked linear fiber laser oscillator may include a comb-locker 12 and an output coupler 14. A polarization-maintaining gain fiber 16 is operatively associated with the comb locker 12 and the output coupler 14. In an example, the gain fiber has normal dispersion. A polarization-maintaining undoped fiber 18 is operatively associated with the comb locker 12 and the output coupler 14. In an example, the undoped fiber has anomalous dispersion.

Fusion splices 20a and 20b are indicated by X's in FIG. 2. In an example, splices may be reduced or eliminating by having the fiber components manufactured with the appropriate fiber. For example, the WDM could be constructed so that it uses only the passive fiber on the SESAM side of the cavity and the gain fiber on the output coupler side of the cavity. In another example, the fiber attachments to the SESAM and the output coupler may be manufactured as part of the WDM assembly.

In an example, the optical spectrum and temporal pulse width can be adjusted to lower phase noise. In addition, the net cavity dispersion can be tailored or specified by adjusting the relative lengths of the passive fiber 18 having anomalous dispersion and rare-earth doped fiber 16 having normal dispersion.

The tuning of the cavity dispersion allows the user to select the mode-locking regime that the laser 10 will operate in. For example, with a net anomalous dispersion cavity, the laser 10 may modelock in the soliton regime. In the soliton regime, a balance between the net-anomalous cavity dispersion and pulse non-linearity yields stable pulse propagation with a near transform limited pulse duration.

To further fine tune the performance of the optical cavity of the laser 10, dispersion management can be applied to the all-PM fiber laser configuration by minimizing the net roundtrip anomalous dispersion. This leads to shorter optical pulses and lower phase noise.

One can also construct net normal roundtrip dispersion all PM laser oscillators. In this case, the oscillator may mode lock in the similariton regime. The similarity regime is favorable for generating high energy pulse and pulse amplification in a normal dispersion gain fiber 16, and gives rise to the formation of a parabolic pulse that undergoes compression in anomalous passive fiber 18.

To build mode locked lasers 10 with these varying mode-locking regimes, only the relative lengths of the normal and anomalous dispersion need to be adjusted. The disposition of optical elements (e.g., the saturable absorber and the output coupler) relative to the constituent optical fibers (gain fiber 16 and passive fiber 18) can be optimized in order to optimize the output pulse length. To calculate the net cavity dispersion, the 2nd order dispersion of fibers used in the cavity can be multiplied by each subsequent length of fiber used and then summed together, as expressed by Equation 2 (EQN 2).

Net cavity dispersion=β_{2,a}·Lₐ+β_{2,b}·L_{b}+ . . . EQN 2

In Equation 2, the subscripts a and b refer to the fibers. To model the temporal and chromatic optical pulse evolution within the cavity, numerically solve the Nonlinear Schrödinger Equation (NLSE), which includes the gain, dispersion, and loss of the fibers.

From this numerical evaluation of the round-trip pulse evolution, two techniques are derived. First, the disposition of optical elements (such as the output coupler and the saturable absorber) relative to the fibers (gain fiber 16 and passive fiber 18) can be set to minimize optical pulse width. Second, the disposition of optical elements (such as the saturable absorber) relative to the other components of the cavity can be selected such that intensity damage thresholds are not exceeded.

It is noted that the dispersion management technique described above may be realized with more than two types of fiber by generalizing Equation 2 and the numerical model to include more than two fibers.

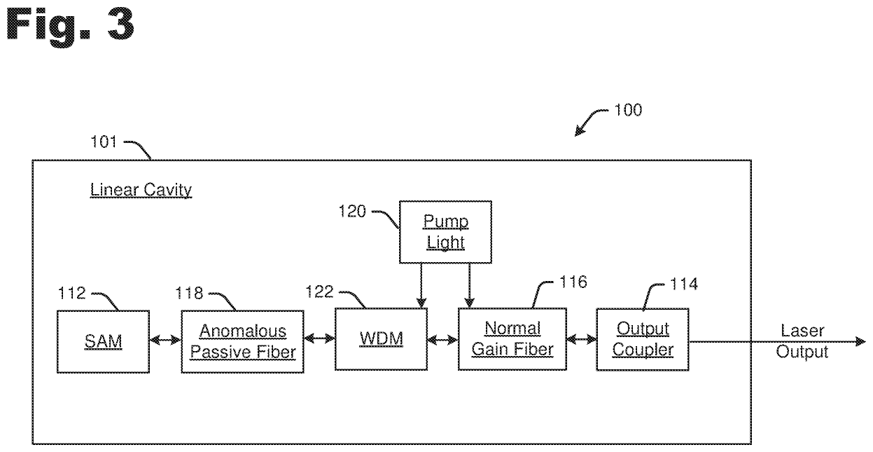

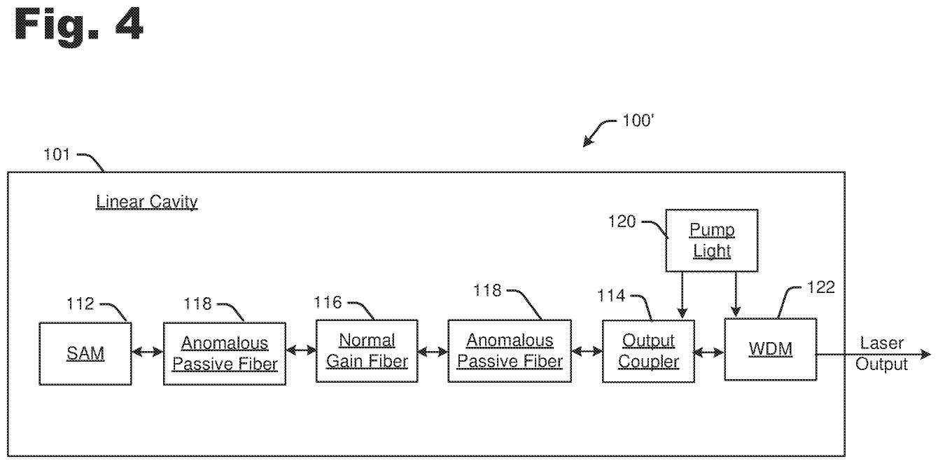

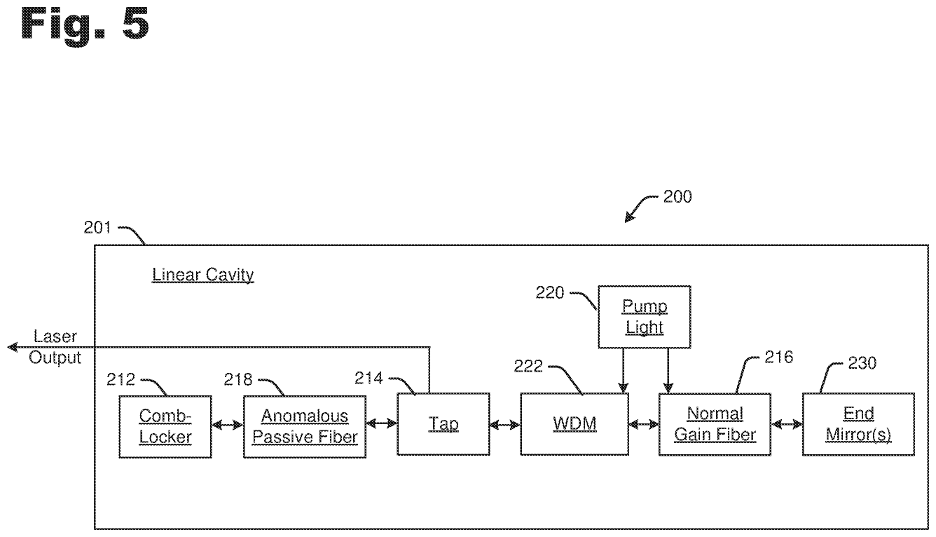

Examples of an all polarization-maintaining, passively mode-locked linear fiber laser oscillator which implement these aspects are described below. One example is an “output coupler” oscillator configuration shown in FIGS. 3 and 4. Another example is a “mid-tap” oscillator configuration shown in FIG. 5. Still other examples which may implement the teachings described herein are also contemplated, as will be readily appreciated by those having ordinary skill in the art after becoming familiar with the teachings herein.

FIG. 3 is a schematic diagram of an example “output coupler” configuration 100 of an example all polarization-maintaining, passively mode-locked linear fiber laser oscillator. FIG. 4 is a schematic diagram of an example “WDM” configuration 100′ of an example all polarization-maintaining, passively mode-locked linear fiber laser oscillator.

An example of the “output coupler” fiber laser oscillator is built with all polarization-maintaining (PM) fiber elements 116 and 118 arranged in a linear fashion between a SAM 112 and a partially-reflecting output coupler 114. On one end of the laser cavity is a SAM 112 that enables the mode-locking within the laser cavity 101. Typically, the SAM 112 is of a semiconductor design (which are referred to herein as a SESAM), but other saturable absorbers are also possible.

In an example, the SAM may be butt-coupled to the fiber end. For optical frequency comb applications that require precise tuning of the repetition rate, this component may also provide a method to change the length of the linear cavity 101. For example, a fiber-coupled “comb-locker” module may include a fiber collimator, a cat's eye lens, and a SESAM mounted to a piezoelectric transducer (PZT). It is noted that there are other techniques to tune the length of the cavity 101, such as fiber stretchers and thermal control.

In an example, the output coupler 114 of the laser oscillator is a thin-film mirror placed at the other end of the cavity opposite the SAM 112. This may be a partial-reflection mirror butt-coupled to the fiber end, or the end of the fiber could be coated with a thin-film partial reflector.

In an example, a pump light 120 can be coupled into the cavity 101 by an output coupler 114 that is transmissive at the pump wavelength.

In an example, a wavelength division multiplexer (WDM) 122 can be incorporated inside of the cavity 101. Though it can introduce extra loss in the laser cavity, the WDM 122 has certain benefits. For example, the WDM 122 and gain fiber 116 can be arranged such that the pump light 120 does not impinge on the SAM 112, thereby avoiding potential damage to the SAM. Also for example, the output coupler 114 may reflect the pump light 120 so as to double pass the gain fiber 116. This recycling of un-absorbed pump light increases the overall power efficiency of the laser.

In an example, the fiber is all PM and includes both anomalous dispersion passive fiber 118 (such as PM1550 fiber) and normal dispersion gain fiber 116 (such as small-core, erbium-doped fiber). In an example, the fiber lengths of the two types of fibers 116 and 118 are adjusted to tune the net cavity dispersion. There are constraints associated with both the minimum and maximum lengths of gain fiber 116 used inside of the oscillator. That is, too little gain fiber 116, and the laser oscillator will not mode-lock. But too much gain fiber 116, and the laser operation may not be stable. This allows designs of the laser cavity 101 in different mode-locking regimes that have different performance characteristics.

In an example, parts or all of the anomalous fiber 118 and normal gain fiber 116 can be changed to adjust the pulse width of the laser oscillator output. For example, the locations of the normal gain fiber 116 and anomalous passive fiber 118 sections may be swapped.

For optical frequency comb applications minimizing losses in the oscillator cavity 101 is critical to lowering the phase noise of the comb modes. As such, the device lends itself to low loss.

It is noted that each fiber splice used to connect fibers and fiber-coupled components introduces losses at the level of 0.1 dB to 10 dB, dependent on the fiber types being joined. An example relates to producing ultrafast pulses in the 1500-1600 nm wavelength regime by using a normal dispersion erbium-doped gain fiber. Because of the large infrastructure of robust fiber and fiber-coupled components available because of the optical telecommunications market, it may be desirable to design oscillators for this wavelength range. As noted above, splices may be reduced or completely eliminated.

FIG. 5 is a schematic diagram of an example “mid-tap” configuration 200 of an example all polarization-maintaining, passively mode-locked linear fiber laser oscillator. The “mid-tap” fiber laser oscillator may be built with all polarization maintaining fiber elements and arranged into a linear cavity 201. In this example, one end of the laser cavity 201 includes a comb-locker 212. The comb-locker 212 includes a fiber collimator, a cat's eye lens, and a SESAM mirror. The other end of the oscillator cavity 201 includes a high reflector or end mirrors 230.

The output coupler of the laser oscillator is a tap 214 or fiber splitter that is located somewhere between the two ends of the cavity 201. Pump light 220 is coupled into the cavity 201 by a WDM 222 inside of the cavity 201. The output coupler fiber splitter and the pump WDM 222 can be integrated into a single device within the cavity 201. The fiber used in this oscillator is all polarization maintaining and consists of both anomalous dispersion passive fiber 218 (such as PM1550 fiber) and normal dispersion gain fiber 216 (such as small-core, erbium doped fiber).

In an example, the fiber lengths of the two types of fibers 216 and 218 may be adjusted to tune the net cavity dispersion. There are constraints associated with both the minimum and maximum lengths of gain fiber 216 used inside of the oscillator. Too little gain fiber 216, and the laser oscillator will not mode-lock. Too much gain fiber 216, and the laser operation may not be stable. This allows configurations of the laser cavity 201 in different mode-locking regimes that have different performance characteristics. For example, parts or all of the anomalous fiber 218 and normal gain fiber 216 may be arranged to adjust the pulse width of the laser oscillator output.

It is noted that the examples shown and described are provided for purposes of illustration and are not intended to be limiting. Still other examples are also contemplated.

1. An all polarization-maintaining, passively mode-locked linear fiber laser oscillator, comprising:
a linear cavity;
a semiconductor saturable absorber mirror (SESAM) disposed at one end of the linear cavity;
a polarization-maintaining gain fiber operatively associated with the SESAM in the linear cavity, the gain fiber having normal dispersion;
a polarization-maintaining undoped fiber operatively associated with the SESAM in the linear cavity, the undoped fiber having anomalous dispersion; and
an output coupler configured to generate laser light output from the linear cavity.

2. The laser oscillator of claim 1, wherein the gain fiber is doped with erbium.

3. The laser oscillator of claim 1, wherein the output coupler is a thin-film mirror disposed at one end of the linear cavity.

4. The laser oscillator of claim 1, wherein the output coupler is a fiber tap coupler disposed between two end mirrors of the linear cavity.

5. The laser oscillator of claim 1, wherein a length of the undoped fiber has an overall cavity dispersion of less than 0 fs² for anomalous dispersion.

6. The laser oscillator of claim 1, wherein a length of the gain fiber has an overall cavity dispersion to be less than 0 fs² for anomalous dispersion.

7. The laser oscillator of claim 1, wherein a length of the undoped fiber has an overall cavity dispersion to be greater than 0 fs² for normal dispersion.

8. The laser oscillator of claim 1, wherein a length of the gain fiber has an overall cavity dispersion to be greater than 0 fs² for normal dispersion.

9. The laser oscillator of claim 1, further comprising a wavelength-division multiplexer (WDM) between the SESAM and an end mirror in the linear cavity.

10. The laser oscillator of claim 9, wherein the WDM couples a pump light to the gain fiber.

11. The laser oscillator of claim 10, wherein the pump light is directed away from the SESAM to not impinge on the SESAM.

12. The laser oscillator of claim 10, wherein the pump light traverses the gain fiber in both a forward direction and a backward direction.

13. The laser oscillator of claim 10, wherein the output coupler is transmissive to the pump light.

14. The laser oscillator of claim 1, wherein no fiber splices are contained within the linear cavity.

15. The laser oscillator of claim 1, wherein the SESAM is attached to a piezo-electric transducer to effectively change a length of the linear cavity.

16. The laser oscillator of claim 1, further comprising a free-space cat's eye retroreflector configured to couple light to the SESAM.

17. The laser oscillator of claim 1, wherein disposition of constituent components in the linear cavity is configured to produce pulse widths on the SESAM between about 200 femtoseconds and 1 picosecond.

18. An all polarization-maintaining passively mode-locked linear fiber laser oscillator, comprising:
a linear cavity;
a semiconductor saturable absorber mirror (SESAM) disposed at one end of the linear cavity;
a polarization-maintaining gain fiber operatively associated with the SESAM in the linear cavity, the gain fiber having normal dispersion;
a polarization-maintaining undoped fiber operatively associated with the SESAM in the linear cavity, the undoped fiber having anomalous dispersion; and
a tap coupler configured to generate laser light output from the linear cavity wherein a position of the tap coupler is adjusted to achieve an output pulse width greater than a transform limited pulse width and a broadened pulse width as determined by net cavity dispersion.

19. The laser oscillator of claim 18, wherein a length of the undoped fiber and a length of the gain fiber both have an overall cavity dispersion of less than 0 fs² for anomalous dispersion.

20. The laser oscillator of claim 18, wherein a length of the undoped fiber and a length of the gain fiber both have an overall cavity dispersion to be greater than 0 fs² for normal dispersion.
